(19) United States
(12) Patent Application Publication
(10) Pub. No.: US 2021/0332914 A1
(43) Pub. Date: Oct. 28, 2021

(54) Critical Containment Room Fluid Feed-Through Assembly

(71) Applicant: Dakota Systems, Incorporated, Dracut, MA (US)

(72) Inventor: John M. Thomas, North Hampton, NH (US)

(21) Appl. No.: 17/238,592

(22) Filed: Apr. 23, 2021

Related U.S. Application Data
(60) Provisional application No. 63/014,835, filed on Apr. 24, 2020.

(51) Int. Cl. F16L 5/08; F16L 33/00

(52) U.S. Cl. CPC F16L 5/08; F16L 33/00

(57) ABSTRACT

A critical containment room feed-through assembly with a weldment comprising a coupling member, a first gasket that is configured to seal the weldment to an interior wall or ceiling of the critical containment room, an escutcheon plate, a second gasket that is configured to seal the escutcheon plate to an exterior surface of the critical containment room directly opposed to the weldment, and a plurality of adjustable coupling devices that are configured to engage both the weldment and the escutcheon plate so as to tighten the weldment, the escutcheon plate, and both of the gaskets against the interior and exterior critical containment room surfaces.

### CROSS-REFERENCE TO RELATED APPLICATION

This application claims the priority of Provisional Patent Application 63/014,835 filed on Apr. 24, 2020.

### BACKGROUND

This disclosure relates to an assembly that allows fluids to be fed through the walls or ceiling of a critical containment room.

Critical containment rooms such as cleanrooms require utility and/or sanitary connections. It can be difficult and expensive to make the necessary utility/sanitary connections while maintaining the required separation between the room's interior and the exterior that are needed in order to maintain the necessary air quality of the critical containment room/cleanroom.

### SUMMARY

Featured in this disclosure are assemblies that are configured to deliver water, gasses, and other fluids through a wall or ceiling of a new or existing critical containment room (e.g., a cleanroom). This allows sanitary and utility feed-through integration before or after a critical containment room/cleanroom has been constructed to support changes to equipment and configuration of the critical containment room/cleanroom or to provide point of use monitor and control to tools not accessible to standard facility connections. The assemblies provide for such feed-through with only minimal openings through the wall/ceiling, while providing seals that maintain the critical containment room air quality despite the openings.

In an example a critical containment room/cleanroom feed-through assembly incorporates a weldment that includes a coupling member, a gasket that is configured to seal the weldment to an interior wall or ceiling of a critical containment room/cleanroom, an escutcheon plate, an additional gasket that is configured to seal the escutcheon plate to an exterior surface of the critical containment room/cleanroom directly opposed to the weldment, and a plurality of adjustable coupling devices that are configured to engage both the weldment and the escutcheon plate so as to tighten the weldment and the escutcheon plate with the gaskets against the interior and exterior critical containment room/cleanroom surfaces. The critical containment room/cleanroom feed-through assembly allows water, gasses, and other fluids to be passed through a wall or ceiling of a new or existing critical containment room/cleanroom while maintaining the critical containment room/cleanroom air quality despite the openings in the wall or ceiling.

All examples and features mentioned below can be combined in any technically possible way.

In one aspect, a critical containment room feed-through assembly includes a weldment comprising a tube coupling member, a first gasket that is configured to seal the weldment to an interior wall or ceiling of a critical containment room, an escutcheon plate, a second gasket that is configured to seal the escutcheon plate to an exterior surface of the critical containment room directly opposed to the weldment, and a plurality of adjustable coupling devices that are configured to engage both the weldment and the escutcheon plate so as to tighten the weldment and the escutcheon plate and the first and second gaskets against the interior and exterior critical containment room surfaces.

Some examples include one of the above and/or below features, or any combination thereof. In an example the tube coupling member is configured to be coupled to a source of water, gas or another fluid to be passed through a wall or ceiling of a new or existing critical containment room. In an example the critical containment room air quality is maintained despite the openings in the wall or ceiling. In an example the coupling devices comprise bolts or screws, and lock nuts for the bolts or screws. In an example the bolts or screws carry gaskets that are configured to seat the bolts or screws to the weldment.

In an example the weldment comprises a weldment plate with a groove that is configured to fit the first gasket. In an example the tube coupling member is welded to the weldment plate. In an example the escutcheon plate comprises a feed-through opening that is configured to allow a tube to be fed through the escutcheon plate, through an opening in the wall or ceiling, and be accepted in the weldment. In an example the critical containment room feed-through assembly further includes a tube that passes through the escutcheon plate, wherein the tube has an end that is part of the weldment and comprises the tube coupling member. In an example the tube coupling member comprises a ferrule.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIGS. 1A-1C are an exploded view of a utility feedthrough, a side assembled view of the utility feedthrough, and a close-up view of the weldment within the utility feedthrough, respectively.

FIGS. 2A-2C are an exploded view of a sanitary feedthrough, a side assembled view of the sanitary feedthrough, and a close-up view of the weldment within the sanitary feedthrough, respectively.

### DETAILED DESCRIPTION

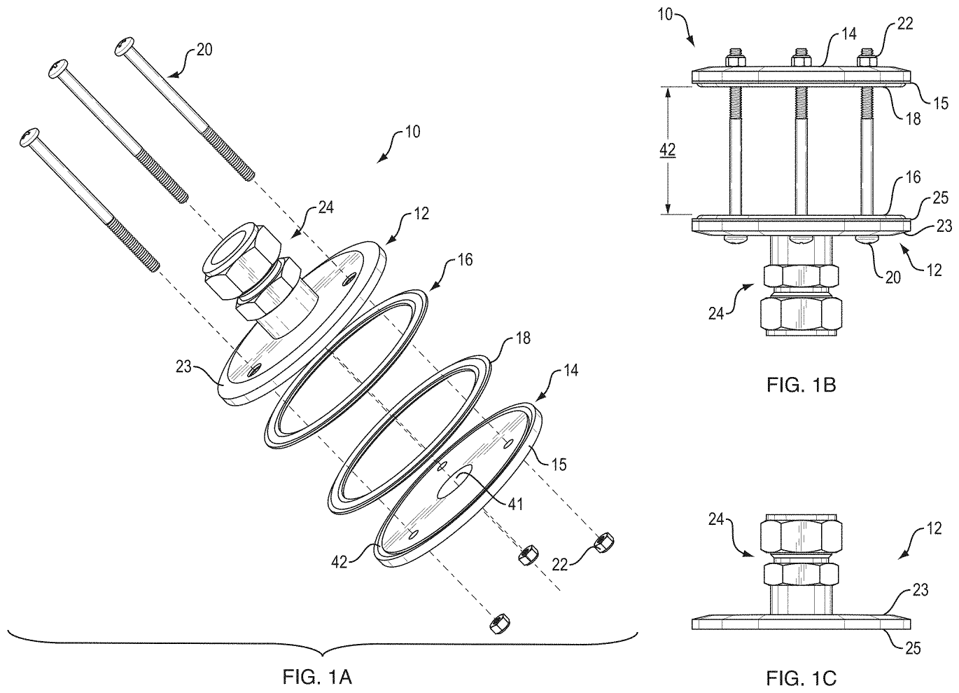

Utility feedthrough 10, FIGS. 1A-1C, includes weldment 12 that is composed of plate 23 and fitting 24. Fitting assembly 24 is welded onto plate 23 at the adjoining face of plate 23. Fitting assembly 24 is able to be coupled to a tube (not shown) inside of the critical containment room/cleanroom that leads to or from the equipment in the critical containment room/cleanroom. Gasket 16 is sized and shaped to fit into a gasket-receiving groove (not shown) on the inside surface 25 of plate 23. Escutcheon plate 14 has inner surface 15 that carries groove 42 to receive gasket 18. Plate 14 is located outside of the critical containment room/cleanroom, against the wall or ceiling directly opposite plate 23. Central feed-through opening 41 in plate 14 allows a tube to be fed through the plate and through a hole created in the critical containment room/cleanroom wall or ceiling (not show) and be coupled to fitting assembly 24. The wall or ceiling is located in the space between the inner surfaces of plate 23 and plate 14 and has a thickness 42. Screws/bolts 20 and lock nuts 22 allow the two plates to be tightened down against the wall or ceiling, to compress gaskets 16 and 18 and thereby seal the critical containment room/cleanroom interior from any contaminants that could enter via the holes created to accommodate the feedthrough and the screws. Screws 20 may carry gaskets (not shown) to seal against the weldment plate.

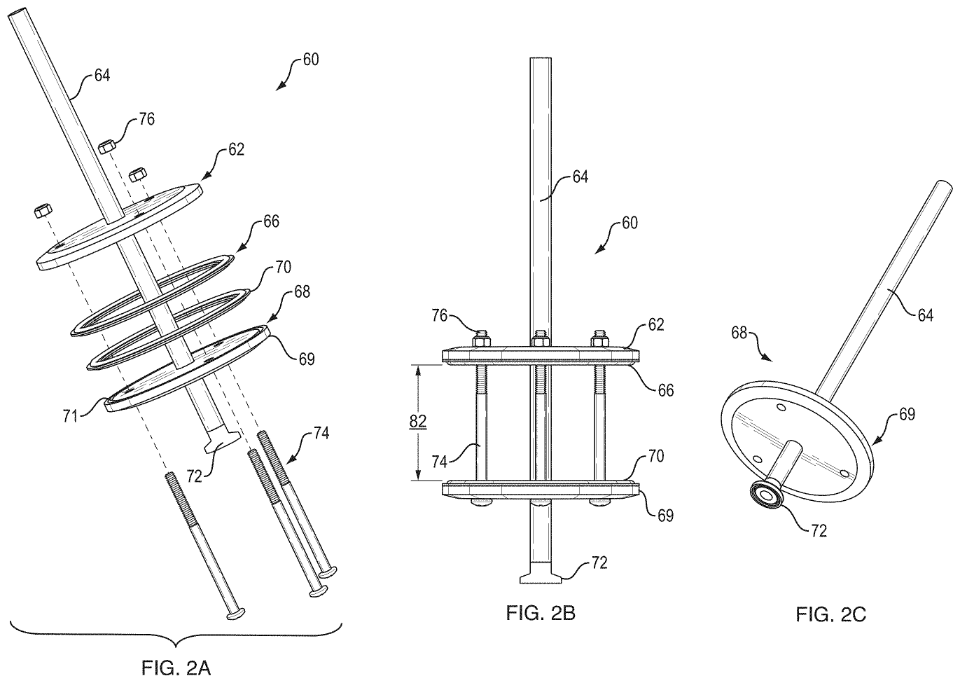

Sanitary feedthrough 60 FIGS. 2A-2C, has a similar construction, with weldment 68 that includes plate 69 with tube 64 welded in a hole through the plate. The weldment 68 contains ferrule 72 at the interior end of tube 64. Ferrule 72 provides for connection to an interior tube (not shown), to conduct media both in the liquid and gaseous state to or from equipment in the critical containment room/cleanroom. Escutcheon plate 62 is located on the outside of the wall or ceiling. Gaskets 66 and 70 accomplish sealing to the wall or ceiling. Gasket-receiving groove 71 in the inside surface of plate 69 is visible. Screws 74 and locknuts 76 allow the assembly to be tightened against a wall or ceiling with thickness 82. Screws 74 may carry gaskets (not shown) to seal against the weldment plate.

Both feedthroughs can be designed to accommodate different diameter tubing that may be necessary to meet the fluid flow requirements. The tubing can be coupled to the feedthrough using any standard tube-coupling system, such as a Swagelok™ system. Tube-coupling systems are well known in the field and so are not further described herein. Furthermore, the feedthrough assemblies may be designed to accommodate slopes in the wall mounted configuration to allow for the appropriate drainage of water or other fluids. The fittings are available to pitch at ⅛ of an inch per foot or other pitch requirements to be fully drainable. The feedthrough assemblies can be manufactured to pitch either into or out of the containment room. All of these pitched fittings are laser marked (e.g., with arrows) reflecting the pitch direction. The feedthroughs allow utility and sanitary connections into a new or existing critical containment rooms/cleanroom with only the need to drill several small holes through the wall or ceiling.

Examples of the systems, methods and apparatuses discussed herein are not limited in application to the details of construction and the arrangement of components set forth in the following description or illustrated in the accompanying drawings. The systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the computer program products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A critical containment room feed-through assembly, comprising:
a weldment comprising a tube coupling member;
a first gasket that is configured to seal the weldment to an interior wall or ceiling of a critical containment room;
an escutcheon plate;
a second gasket that is configured to seal the escutcheon plate to an exterior surface of the critical containment room directly opposed to the weldment; and
a plurality of adjustable coupling devices that are configured to engage both the weldment and the escutcheon plate so as to tighten the weldment and the escutcheon plate and the first and second gaskets against the interior and exterior critical containment room surfaces.

2. The critical containment room feed-through assembly of claim 1, wherein the tube coupling member is configured to be coupled to a source of water, gas or another fluid to be passed through a wall or ceiling of a new or existing critical containment room.

3. The critical containment room feed-through assembly of claim 2, wherein the critical containment room air quality is maintained despite the openings in the wall or ceiling.

4. The critical containment room feed-through assembly of claim 1, wherein the coupling devices comprise bolts or screws, and lock nuts for the bolts or screws.

5. The critical containment room feed-through assembly of claim 4, wherein the bolts or screws carry gaskets that are configured to seat the bolts or screws to the weldment.

6. The critical containment room feed-through assembly of claim 1, wherein the weldment comprises a weldment plate with a groove that is configured to fit the first gasket.

7. The critical containment room feed-through assembly of claim 6, wherein the tube coupling member is welded to the weldment plate.

8. The critical containment room feed-through assembly of claim 1, wherein the escutcheon plate comprises a feed-through opening that is configured to allow a tube to be fed through the escutcheon plate, through an opening in the wall or ceiling, and be accepted in the weldment.

9. The critical containment room feed-through assembly of claim 1, further comprising a tube that passes through the escutcheon plate, wherein the tube has an end that is part of the weldment and comprises the tube coupling member.

10. The critical containment room feed-through assembly of claim 9, wherein the tube coupling member comprises a ferrule.
